(19) United States
(12) Patent Application Publication
(10) Pub. No.: US 2013/0091145 A1
(43) Pub. Date: Apr. 11, 2013

(54) METHOD AND APPARATUS FOR ANALYZING WEB TRENDS BASED ON ISSUE TEMPLATE EXTRACTION

(71) Applicants: Jeong Heo, Daejeon (KR); Pum Mo Ryu, Daejeon (KR)

(72) Inventors: Jeong Heo, Daejeon (KR); Pum Mo Ryu, Daejeon (KR)

(73) Assignee: Electronics and Telecommunications Research Institute, Daejeon (KR)

(21) Appl. No.: 13/614,558

(22) Filed: Sep. 13, 2012

(30) Foreign Application Priority Data
Oct. 7, 2011 (KR) 10-2011-0102568

(51) Int. Cl. G06F 17/30

(52) U.S. Cl. 707/748; 707/754; 707/E17.009

(57) ABSTRACT

An apparatus analyzes web trends based on issue template extraction. The apparatus includes a web document collector to collect web documents provided through web, a web document filter to filter useless documents from the collected web documents, and an issue detector to detect new issues in the filtered documents. Also, the apparatus further includes an issue template extractor to extract detailed attribute values of issue templates with respect to the detected new issues, an issue template integrator to integrate the extracted issue templates based on an identical entity and an identical event, and an issue monitor configured to monitor information on changes on a time axis using the integrated issue template.

### RELATED APPLICATION(S)

This application claims the benefit of Korean Patent Application No. 10-2011-0102568, filed on Oct. 7, 2011, which is hereby incorporated by reference as if fully set forth herein.

### FIELD OF THE INVENTION

The present invention relates to a technique of extracting web and social media information, and more particularly, to a method and apparatus for analyzing web trends based on issue template extraction, which are suitable for monitoring facts and netizens' opinions on main issues detected by web and social media.

### BACKGROUND OF THE INVENTION

Conventional approaches of techniques web and social media information include a technique of monitoring issues on web based on a change in the frequency of keywords, that is, issues in documents, a technique of extracting information on opinions on issues from the web to present the information, a technique of extracting a triple relationship of a syntax/vocabulary level between entities on the web, and the like.

The technique of monitoring issues on web based on a change in the frequency of issues in documents has a disadvantage in that changes in detailed attributes of the issues may not be observed on a time axis and the technique of extracting information on opinions on issues from the web has a disadvantage in that information on facts on the issues may not be observed since only information on the opinions is extracted. In addition, technique of extracting a triple relationship of a syntax/vocabulary level between entities on the web does not include a way of generalizing the relationship of the syntax/vocabulary level, expressing the generalized relationship of the syntax/vocabulary level as a meaning relationship, and integrating the generalized relationship of the syntax/vocabulary level into a template.

### SUMMARY OF THE INVENTION

In view of the above, therefore, the present invention provides a technique of analyzing web trends based on issue template extraction, which is capable of providing thoughtful insight into the web trends to users based on information on detailed attributes of issues that dynamically change on a time axis.

In accordance with an aspect of the present invention, there is provided an apparatus for analyzing web trends based on issue template extraction, which includes: a web document collector configured to collect web documents provided through web; a web document filter configured to filter useless documents from the collected web documents; an issue detector configured to detect new issues in the filtered documents; an issue template extractor configured to extract detailed attribute values of issue templates with respect to the detected new issues; an issue template integrator configured to integrate the extracted issue templates based on an identical entity and an identical event; and an issue monitor configured to monitor information on changes on a time axis using the integrated issue template.

The apparatus further includes an issue knowledge base corrector configured to define entity and event templates used for extracting template information on the new issues; and an issue knowledge base storing the issue templates based on the defined entity and event templates.

In addition, the apparatus further includes: a web document database storing web documents collected by the Web document collector; a web document database storing documents filtered by the web document filter; an issue database storing the new issues detected by the issue detector; an issue template database storing detailed attribute values of the issue templates extracted by the issue template extractor; and an issue template database storing issue templates integrated by the issue template integrator.

In the apparatus, the web documents include at least one of newspaper, blogs, and social media information.

In the apparatus, the useless documents include at least one of spam documents, false reputation documents, and biased documents.

In the apparatus, the information on changes on the time axis includes at least one of the frequency of issues, association issues, and attribute values.

In the apparatus, the web document filter includes: a spam document filtering unit configured to filter documents including advertisements and documents in which specific keywords are intentionally and repeatedly described in order to raise the rankings of the specific words; a false reputation filtering unit configured to filter repeatedly and intentionally posted false reputations on specific issues having an effect on the reputations on the specific issues; and a biased document filtering unit configured to filter documents of opinions biased in one direction on the specific issues.

In the apparatus, the web documents are filtered as refined web documents through the spam document filtering unit, the false reputation filtering unit, and the biased document filtering unit.

In the apparatus, the issue in the issue knowledge base is classified into an entity class and an event class to hierarchically define the issue.

In the apparatus, at least one of detailed attributes, types of attribute values, and constraint conditions of attribute values is defined in the entity class and the event class.

In the apparatus, the issue template integrator includes: an attribute value normalizing unit configured to normalize an attribute value having in different types to generate a normalized attribute value; an identical entity integrating unit configured to find identical entities in multiple entity and event templates to integrate the searched identical entities into one node; and an identical event integrating unit configured to find identical events in the event templates to integrate the identical events into one event.

In accordance with another aspect of the present invention, there is provided a method for analyzing web trends based on issue template extraction, which includes: collecting web documents provided through web; filtering useless documents from the collected web documents; detecting new issues in the filtered documents; extracting detailed attribute values of issue templates with respect to the detected new issues; integrating the extracted issue templates based on an identical entity and an identical event; and providing information on changes on a time axis to a monitor to be displayed using the integrated issue template.

The method further includes: defining entity and event templates used for extracting template information on the new issues; and storing issue templates based on the defined entity and event templates on an issue template database.

In the method, the web documents include at least one of newspaper, blogs, and social media information.

In the method, the useless documents include at least one of spam documents, false reputation documents, and biased documents.

In the method, the information on changes on the time axis includes at least one of the frequency of issues, association issues, and attribute values.

In the method, said filtering useless documents includes: filtering spam documents including advertisements and spam documents in which specific keywords are intentionally and repeatedly described in order to raise the rankings of the specific words; filtering repeatedly and intentionally posted false reputations on specific issues having an effect on the reputations on the specific issues; and filtering documents of opinions biased in one direction on the specific issues.

In the method, the filtering useless documents comprises generating refined web documents through the filtering of the spam documents, the filtering repeatedly and intentionally posted false reputations, and the documents of biased opinions.

In addition, the method further includes: dividing the new issues into an entity class and an event class to hierarchically define the new issues.

In the method, the integrating the extracted issue templates includes: normalizing an attribute value having in different types to generate a normalized attribute value; finding identical entities in multiple entity and event templates to integrate the searched identical entities into one node; and finding identical events in the event templates to integrate the identical events into one event.

### BRIEF DESCRIPTION OF THE DRAWINGS

The above and other objects and features of the present invention will become apparent from the following description of preferred embodiments, given in conjunction with the accompanying drawings, in which:

FIG. 1 illustrates a block diagram of an apparatus for analyzing web trends based on issue template extraction in accordance with an embodiment of the present invention;

FIG. 2 illustrates a detailed block diagram of the web document filtering unit of FIG. 1;

FIG. 3 illustrates a conceptual diagram of the issue knowledge base of FIG. 1;

FIG. 4 is a view exemplarily illustrating detailed attributes of an arbitrary entity class defined by the issue knowledge base;

FIG. 5 is a view exemplarily illustrating attribute values extracted with reference to the detailed attributes of the entity class of FIG. 4;

FIG. 6 is a view exemplarily illustrating detailed attributes of an arbitrary event class defined by the issue knowledge base;

FIG. 7 is a view exemplarily illustrating an event template extracted from the attribute value of FIG. 5;

FIG. 8 illustrates a detailed block diagram of the issue template integrating unit of FIG. 1;

FIG. 9 is a view exemplarily illustrating a result of integrating an identical entity in FIGS. 5 and 7; and

FIGS. 10A and 10B are views exemplarily illustrating a result of integrating the event templates of FIG. 7.

### DETAILED DESCRIPTION OF THE EMBODIMENTS

Hereinafter, embodiments of the present invention will be described in detail with reference to the accompanying drawings so that they can be readily implemented by those skilled in the art.

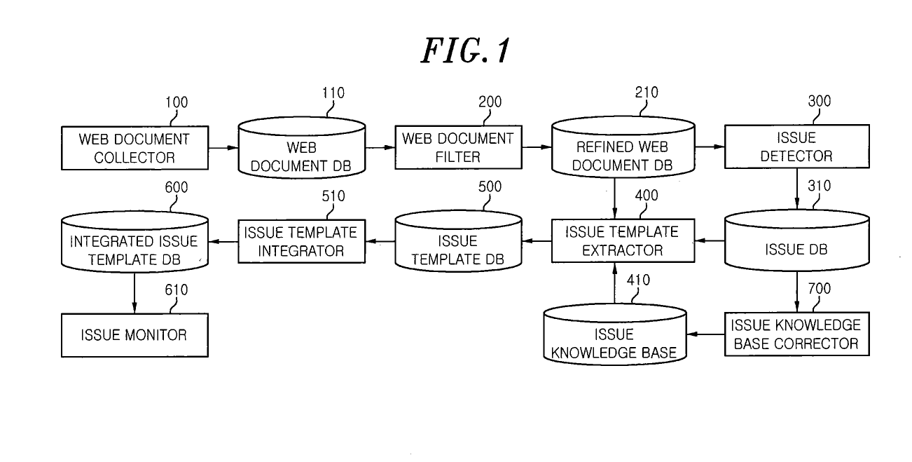

FIG. 1 is a block diagram of an apparatus for analyzing web trends based on issue template extraction in accordance with an embodiment of the present invention. The apparatus of the embodiment includes a web document collector 100, a web document database (DB) 110, a web document filter 200, a refined web document DB 210, an issue detector 300, an issue DB 310, an issue knowledge base corrector 700, an issue template extractor 400, an issue knowledge base 410, an issue template DB 510, an issue template integrator 500, an integrated issue template DB 610, and an issue monitor 600.

As illustrated in FIG. 1, the web document collector 100 collects various web documents provided through web, for example, newspaper, blogs, social media information and the like. The collected web documents is then stored in the web document DB 110.

The web document filter 200 filters useless documents such as documents with worthless information (for example, spam documents), false reputation documents, documents with biased contents or the like from among the documents stored in the web document DB 110. The filtered documents is then stored in the refined web document DB 210.

The issue detector 300 detects new issues from the filtered documents stored in the refined web document DB 210. The detected new issues is then stored in the issue DB 310.

The issue knowledge base corrector 700 defines entities and event templates used for extracting template information on the detected new issues. The defined entities and event templates are then stored in the issue knowledge base 410.

The issue template extractor 400 extracts detailed attribute values of issue templates with respect to the new issues stored in the issue DB 310 based on the entity and event templates, which are defined by the issue knowledge base 410, from the refined web document DB 210. The extracted attribute values is then stored in the issue template DB 510.

The issue template integrator 500 integrates the issue templates, which are stored in the issue template DB 510, based on an identical entity and an identical event. The integrated issue templates is then stored in the integrated issue template DB 610.

The issue monitor 600 monitors information on changes on a time axis, for example, information on changes in the frequency of issues, associated issues, attribute values and the like using the issue templates stored in the integrated issue template DB 610. The information on changes may be displayed to a user through the issue monitor 600. For example, the issue monitor may include a display unit such as an LCD (liquid crystal display) or the like.

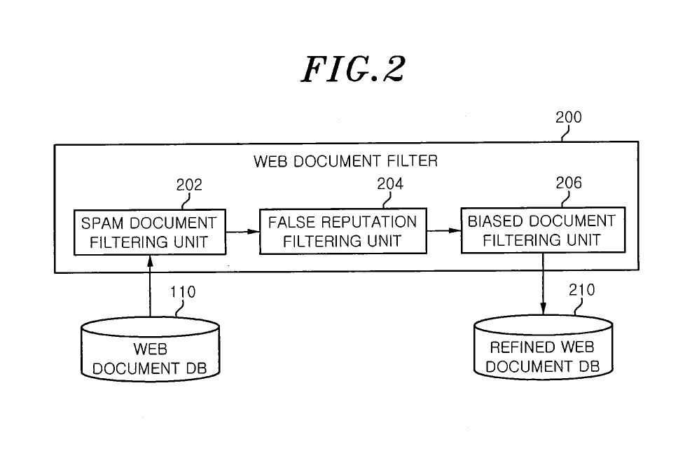

FIG. 2 illustrates a detailed block diagram of the web document filter 200 of FIG. 1. The web document filter 200 includes a spam document filtering unit 202, a false reputation filtering unit 204, and a biased document filtering unit 206.

As illustrated in FIG. 2, the spam document filtering unit 202 filters spam documents including advertisements and spam documents in which specific keywords are intentionally and repeatedly described in order to raise the rankings of the specific keywords in a web search system.

The false reputation filtering unit 204 filters repetitively and intentionally posted false reputations on specific issues which may affect the reputations on the specific issues.

The biased document filtering unit 206 filters documents containing opinions socially biased in one direction on the specific issues.

Therefore, the web documents provided to the web document filter 200 is filtered by the spam document filtering unit 202, the false reputation filtering unit 204, and the biased document filtering unit 206, thereby providing the refined web documents.

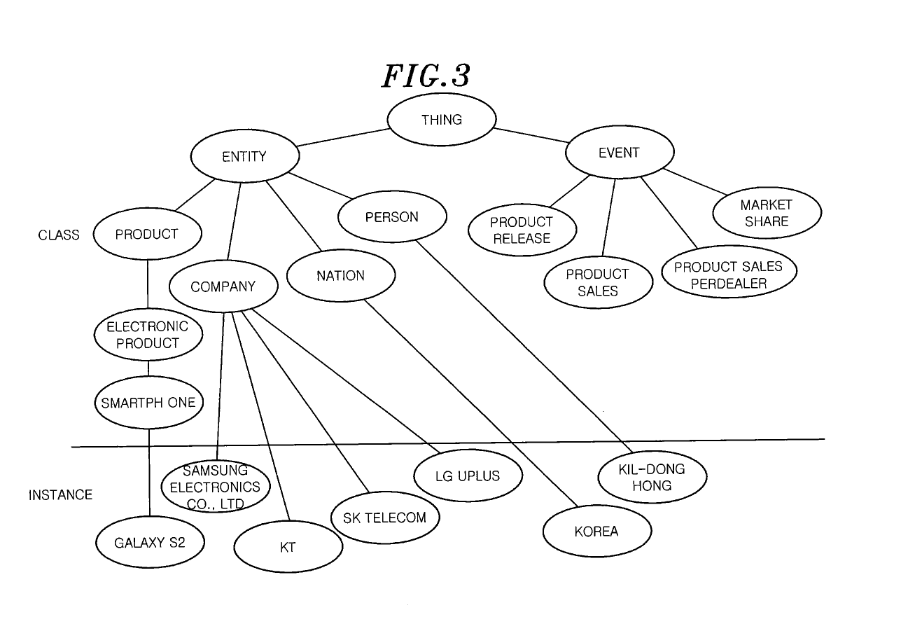

FIG. 3 illustrates a conceptual diagram of the issue knowledge base 410 of FIG. 1.

Referring to FIG. 3, in the issue knowledge base 410, an issue may be classified into an entity class and an event class to hierarchically define the issue. For example, the entity class may include Product, Company, Nation, Person and the like and the event class may include Product Release, Product Sales, Product Sales per Dealer, Market Share and the like.

Instances found in a real document are mapped in the entity class. For example, the instance may include Galaxy S2, Samsung Electronics Co., Ltd, and the like. Detailed attributes, types of attribute values, constraint conditions of attribute values or the like may be defined in all of the event classes and the entity classes.

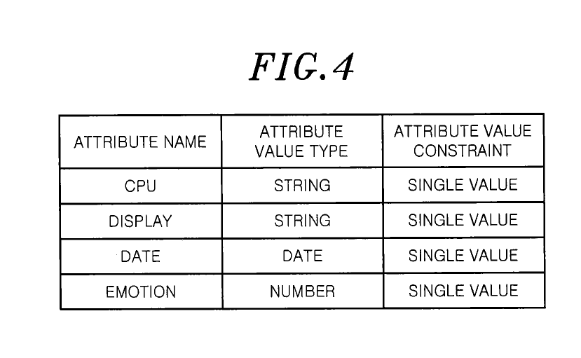

FIG. 4 is a view exemplarily illustrating detailed attributes of an arbitrary entity class defined in the issue knowledge base 410.

Referring to FIG. 4, there is illustrated an example of definition of detailed attributes of an arbitrary class among the entity classes defined by the issue knowledge base 410, for example, a class SmartPhone.

Types of attribute values describe data types of attribute values.

Constraints on attribute values define whether corresponding attributes have single values or multiple values. For example, since a specific class SmartPhone has only one central processing unit (CPU), it may have single value constraint.

An attribute Emotion is obtained by extracting emotion information on its entity on web to numerically quantize the emotion information.

All of the entity classes may have an attribute date. Changes in attribute values of the same entity may be observed based on the date information.

The detailed attribute values of all the entity instances registered in the issue knowledge base 410 are extracted by the issue template extractor 400 through an automatic document analyzing process.

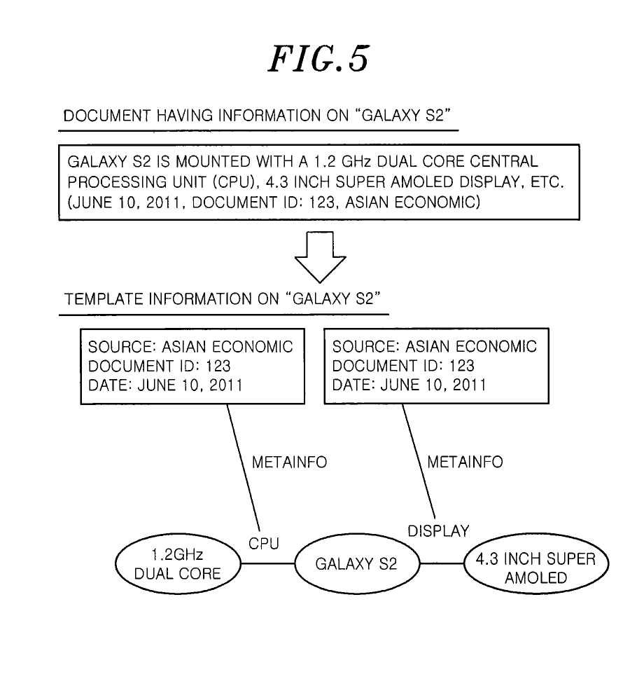

FIG. 5 is a view exemplarily illustrating attribute values extracted with reference to the detailed attributes of the entity class of FIG. 4.

Referring to FIG. 5, an example of attribute values extracted from a document describing Galaxy S2 that is an instance of the class SmartPhone, based on the definition of the attributes of the class SmartPhone of FIG. 4 is illustrated.

Attribute values are extracted from a given document for each attribute of an entity and are managed in the form of templates. Information on the source and the date of a document from which the attribute values are extracted may be recorded as metainfo.

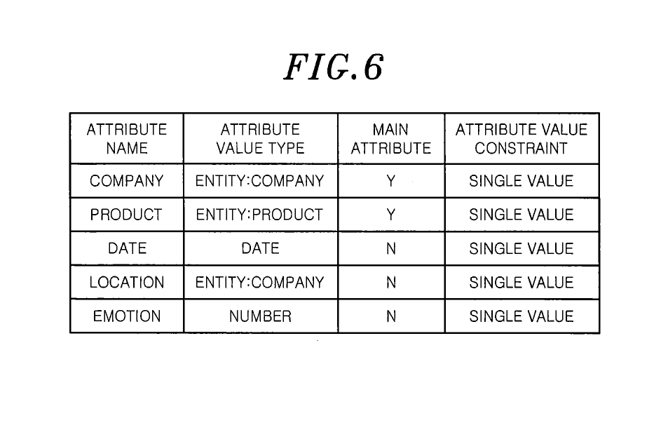

FIG. 6 is a view exemplarily illustrating detailed attributes of an arbitrary event class defined by the issue knowledge base 410.

Referring to FIG. 6, an example of definition of detailed attributes of an arbitrary class among event classes defined by the issue knowledge base 410, for example, a class ProductRelease is illustrated.

In attribute value types, ENTITY:COMPANY, ENTITY:PRODUCT, and ENTITY:NATION represent constraint conditions in which entity instances of corresponding types may be provided as attribute values.

All of the event classes may have attributes of Date and Location.

An attribute Emotion is obtained by extracting emotion information on a corresponding event on web to numerically quantize the emotion information.

An attribute having main attribute of Y may represent an attribute for distinguishing a corresponding event from a different event of the same type.

An event ProductRelease may have the main attributes of Company and Product.

Attribute value constraints define whether values of corresponding attributes have single values or multiple values. For example, in the event ProductRelease, an attribute Company may have only one attribute value, but an attribute Location may have various attribute values.

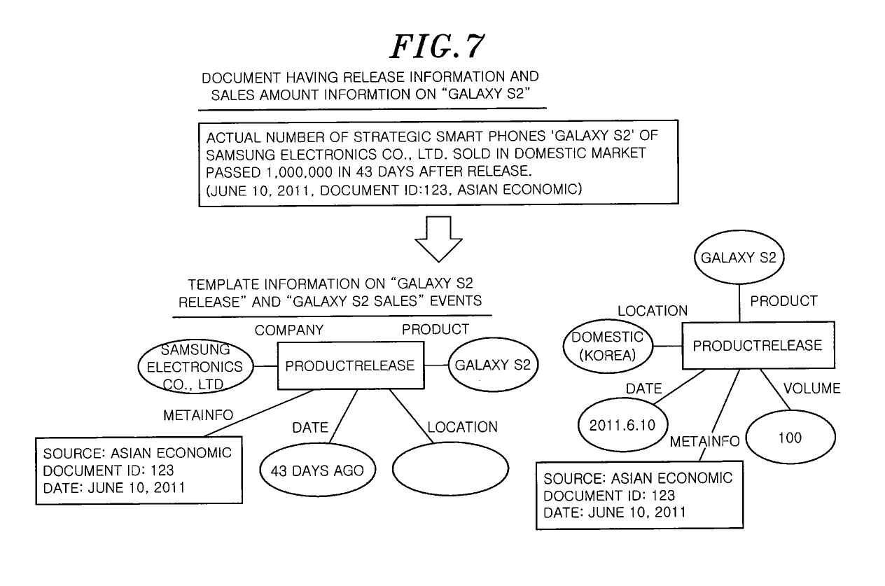

FIG. 7 is a view exemplarily illustrating an event template extracted from the attribute value of FIG. 5.

Referring to FIG. 7, for example, information on an event ProductRelease and an event ProductSales for Galaxy S2 of an instance is extracted from a document in which release information on Galaxy S2 and sales amount information on Galaxy S2 are provided, so as to express in the form of a template.

Information on the source and the date of a document from which the events are extracted is recorded as metainfo. 43 days ago expressed as a relative value may be converted into Apr. 28, 2011 based on the date of a document extracted through a date normalizing process.

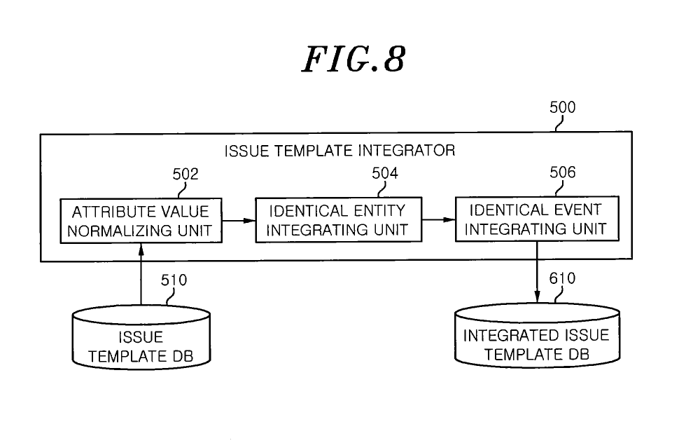

FIG. 8 illustrates a detailed block diagram of the issue template integrator 500 of FIG. 1. The issue template integrator 500 includes an attribute value normalizing unit 502, an identical entity integrating unit 504, and an identical event integrating unit 506.

As illustrated in FIG. 8, the template integrating unit 500 integrates the templates extracted by the template extracting unit 400 through the use of the attribute value normalizing unit 502, the identical entity integrating unit 504, and the identical event integrating unit 506 to generate an integrated template.

First, the attribute value normalizing unit 502 normalizes an attribute value such as date, number, location, etc which may be expressed in different types to generate a normalized attribute value.

The identical entity integrating unit 504 finds identical entities in a plurality of entity and event templates to integrate the identical entities as one node.

The identical event integrating unit 506 finds identical events in multiple event templates to integrate the identical events as one event. For example, events in which event types are identical and values of main attributes are the same are determined as the same event. In addition, when attribute values of templates coincide with each other in the identical entity integration and identical event integration, determination may be made in accordance with a priority in their attributes. The integrations of identical entities and identical events may be performed on entities and events, which are extracted from a system at each predetermined time, by predefined periods.

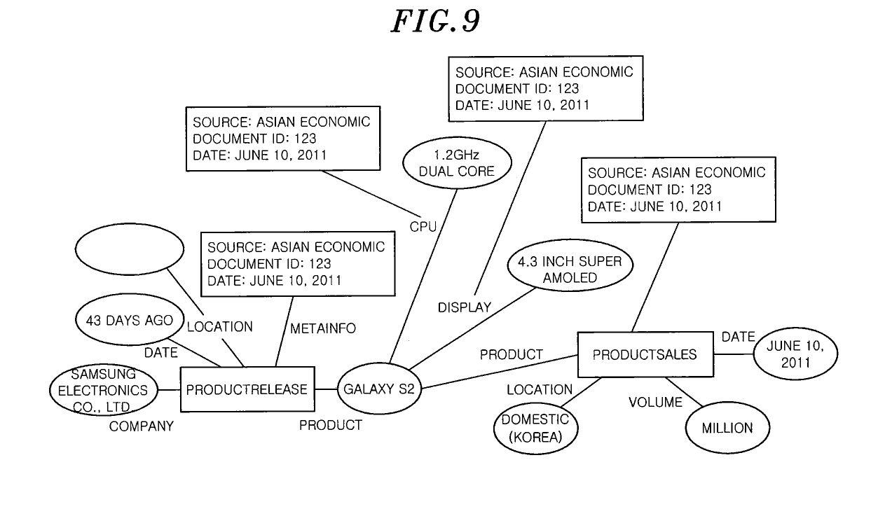

FIG. 9 is a view exemplarily illustrating a result of integrating the identical entities in FIGS. 5 and 7. In particular, FIG. 9 illustrates a result of performing identical entity integration on template information such as Galaxy S2 in FIG. 5 and event templates such as GALAXY S2 Release and GALAXY S2 Sales in FIG. 7.

In FIG. 9, since Galaxy S2 is an identical entity in three templates, Galaxy S2 is integrated into one node.

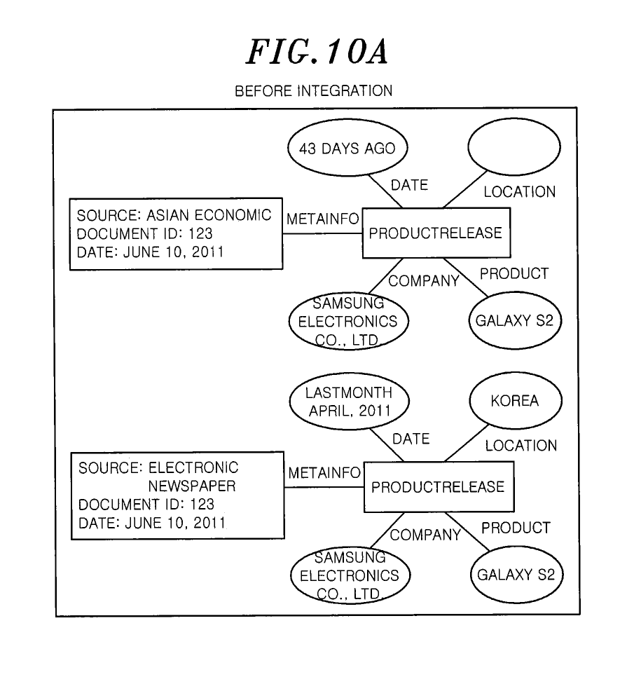

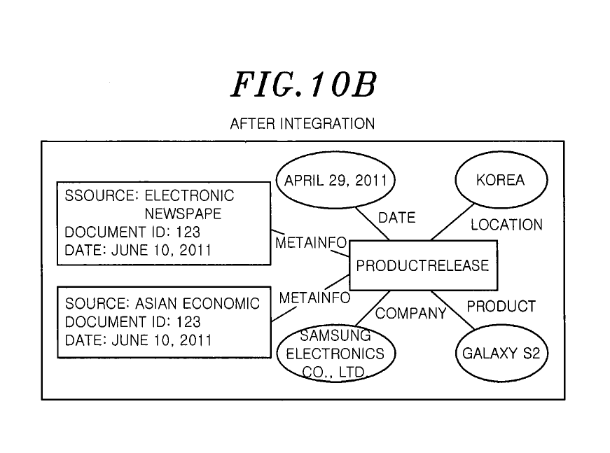

FIGS. 10A and 10B are views exemplarily illustrating a result of integrating the event templates as shown in FIG. 7.

Referring to FIGS. 10A and 10B, since the attribute values of main attributes product and company are the same as those of Galaxy S2 and Samsung Electronics Co., Ltd. in two ProductRelease events, respectively, the two ProductRelease events are determined as the same event.

As set forth above, an identical attribute with an identical attribute value is expressed as one node. An identical attribute with different attribute values has one or plural expression based on the criterion in each attribute.

For example, in the ProductRelease event of FIG. 6, since an attribute Date is defined as a single value in defining detailed attributes of the class ProductRelease, the attribute Date is to be expressed as one attribute value.

In this case, one attribute value is selected with reference to the criterion in each attribute. In the embodiment, a more detailed attribute value Apr. 29, 2011 is selected.

Metadata may be doubly after integrating the event templates in this way.

In accordance with the embodiment, unlike in a conventional method of performing monitoring on each issue based on the frequency of issues, changes in attribute values of the issues may be additionally observed on a time axis and a large graph structure created by binding various templates may be searched to detect associated issues that are not explicitly expressed in texts. In addition, in accordance with the embodiment, a meaning relationship based on facts is extracted and spam filtering, false reputation filtering, biased document filtering and the like are performed on collected web documents, thereby improving reliability of information extraction.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for analyzing web trends based on issue template extraction, the apparatus comprising:
a web document collector configured to collect web documents provided through web;
a web document filter configured to filter useless documents from the collected web documents;
an issue detector configured to detect new issues in the filtered documents;
an issue template extractor configured to extract detailed attribute values of issue templates with respect to the detected new issues;
an issue template integrator configured to integrate the extracted issue templates based on an identical entity and an identical event; and
an issue monitor configured to monitor information on changes on a time axis using the integrated issue template.

2. The apparatus of claim 1, further comprising:
an issue knowledge base corrector configured to define entity and event templates used for extracting template information on the new issues; and
an issue knowledge base storing the issue templates based on the defined entity and event templates.

3. The apparatus of claim 1, further comprising:
a web document database storing web documents collected by the Web document collector;
a web document database storing documents filtered by the web document filter;
an issue database storing the new issues detected by the issue detector;
an issue template database storing detailed attribute values of the issue templates extracted by the issue template extractor; and
an issue template database storing issue templates integrated by the issue template integrator.

4. The apparatus of claim 1, wherein the web documents comprise at least one of newspaper, blogs, and social media information.

5. The apparatus of claim 1, wherein the useless documents comprise at least one of spam documents, false reputation documents, and biased documents.

6. The apparatus of claim 1, wherein the information on changes on the time axis comprises at least one of the frequency of issues, association issues, and attribute values.

7. The apparatus of claim 1, wherein the web document filter comprises:
a spam document filtering unit configured to filter documents including advertisements and documents in which specific keywords are intentionally and repeatedly described in order to raise the rankings of the specific words;
a false reputation filtering unit configured to filter repeatedly and intentionally posted false reputations on specific issues having an effect on the reputations on the specific issues; and
a biased document filtering unit configured to filter documents of opinions biased in one direction on the specific issues.

8. The apparatus of claim 7, wherein the web documents are filtered as refined web documents through the spam document filtering unit, the false reputation filtering unit, and the biased document filtering unit.

9. The apparatus of claim 2, wherein the issue in the issue knowledge base is classified into an entity class and an event class to hierarchically define the issue.

10. The apparatus of claim 9, wherein at least one of detailed attributes, types of attribute values, and constraint conditions of attribute values is defined in the entity class and the event class.

11. The apparatus of claim 1, wherein the issue template integrator comprises:
an attribute value normalizing unit configured to normalize an attribute value having in different types to generate a normalized attribute value;
an identical entity integrating unit configured to find identical entities in multiple entity and event templates to integrate the searched identical entities into one node; and
an identical event integrating unit configured to find identical events in the event templates to integrate the identical events into one event.

12. A method for analyzing web trends based on issue template extraction, the method comprising:
collecting web documents provided through web;
filtering useless documents from the collected web documents;
detecting new issues in the filtered documents;
extracting detailed attribute values of issue templates with respect to the detected new issues;
integrating the extracted issue templates based on an identical entity and an identical event; and
providing information on changes on a time axis to a monitor to be displayed using the integrated issue template.

13. The method of claim 12, further comprising:
defining entity and event templates used for extracting template information on the new issues; and
storing issue templates based on the defined entity and event templates on an issue template database.

14. The method of claim 12, wherein the web documents comprise at least one of newspaper, blogs, and social media information.

15. The method of claim 12, wherein the useless documents comprises at least one of spam documents, false reputation documents, and biased documents.

16. The method of claim 12, wherein the information on changes on the time axis comprises at least one of the frequency of issues, association issues, and attribute values.

17. The method of claim 12, wherein said filtering useless documents comprises:
filtering spam documents including advertisements and spam documents in which specific keywords are intentionally and repeatedly described in order to raise the rankings of the specific words;
filtering repeatedly and intentionally posted false reputations on specific issues having an effect on the reputations on the specific issues; and
filtering documents of opinions biased in one direction on the specific issues.

18. The method of claim 17, wherein said filtering useless documents comprises generating refined web documents through the filtering of the spam documents, the filtering repeatedly and intentionally posted false reputations, and the documents of biased opinions.

19. The method of claim 12, further comprising:
dividing the new issues into an entity class and an event class to hierarchically define the new issues.

20. The method of claim 12, wherein said integrating the extracted issue templates comprises:
normalizing an attribute value having in different types to generate a normalized attribute value;
finding identical entities in multiple entity and event templates to integrate the searched identical entities into one node; and
finding identical events in the event templates to integrate the identical events into one event.
